(19) United States
(12) Patent Application Publication
(10) Pub. No.: US 2011/0079110 A1
(43) Pub. Date: Apr. 7, 2011

(54) Mountable bottle opener and removable cap holder

(76) Inventor: Christopher John Previte, Wilton, CT (US)

(21) Appl. No.: 12/899,623

(22) Filed: Oct. 7, 2010

Related U.S. Application Data
(60) Provisional application No. 61/249,288, filed on Oct. 7, 2009.

(51) Int. Cl. B67B 7/44; B67B 7/16; B23P 19/04

(52) U.S. Cl. 81/3.15; 81/3.55; 29/428

(57) ABSTRACT

A mountable bottle opener and a removable bottle cap holder. The holder hangs from the bottle opener on an angled portion of the opener. The holder may be removed by pulling it off the opener to empty its contents. The holder has a slot into which is fitted further a curved portion of the opener and then the angled portion. The opener also has a flat portion mounted to a flat surface. The angled portion projects forward from a top end of the flat portion. The curved portion projects from the angled portion. The curved portion includes edges that define an open window that enable bottle caps to be pried off. The holder is arranged with its mouth beneath where the prying occurs to catch pried off caps.

### CROSS-REFERENCE TO RELATED PATENT APPLICATION

The present application claims the benefit of priority from U.S. provisional patent application No. 61/249,288 filed Oct. 7, 2009.

### BACKGROUND OF THE INVENTION

Preparing for a July 2009 camping trip with friends and family, I had to remember to bring a bottle opener. I also had to think about where to put the opener so it wouldn't get lost. My other problems were that I would be wearing shorts most of the time with no pockets so I could not keep an opener on me. I have tried to keep the openers in the coolers but they would get lost on the bottom with the ice and bottles. The other problem was the caps. Going to a camp or picnic grounds, I didn't want people to litter caps if a garbage can wasn't convenient.

The days before the trip I modified a flat bottle opener and made a holder to catch the caps. It was mounted together on my small cooler, with the opener and screws going through both. It turned out to be very convenient, well liked, but was flawed. The angle of the bottle to use the opener caused the beverage to spill when it was opened. The other problem was the caps missed the holder because the holder was too small and the caps dropped to the front of the bottle when pried off. Caps would be picked off the ground and placed in the holder. To empty the holder I had to dig the caps out with my fingers and bring them to the garbage in my hand. The original holder I made with sheet metal. That could be sharp and would not do well if bumped while in transit. It could only hold about six caps, so it had to be emptied often. Since the cooler and the opener would normally be located at knee level a few feet from the ground. The small opener was also hard to locate the location of the prying tab with a bottle in hand was sometimes difficult.

The next group of prototypes #2 had to address the problems of: holder was too small, hard to locate pry area, angle of the opener and bottle when used, the material used for the opener, holder had to be able to come off to empty caps.

The next group of prototypes had a larger opener with a window so the cap could be seen from above. The opener window and pry edge were increased to make the loading of a bottle and cap easier. The holder was made larger for more caps and was mounted to the front of the opener. Both the opener and holder were made larger but size had to be limited as much as possible to keep it compact. This prototype had a problem with the holder and opener attached together. The whole unit had to be removed so it could be emptied. Then, be reinstalled for the next use. It also couldn't come off accidentally while being used or moved with the cooler. Velcro was used but wasn't strong enough to keep it mounted when in use. That is when I realized that only holder had to be removed. It had to be easily removable, easy to reinstall, easy to manufacture, not to big and not to small. The opener had the pry edge on the bottom of the window, which caused the caps to drop in front of the bottle. This caused the caps to miss the holder. The new angle of the loading angle, about 27 degrees is ideal for no beverage spill. The window and pry edge were the correct size for easy use.

The problems that needed to be addressed now on prototype #3 were: caps falling to the front of the bottle, the holder needed to be able to be removed and installed with ease, the opener had to be easily secured to the cooler or other surfaces. It is therefore desired to provide a mountable opener and removable cap holder that solves these problems.

### SUMMARY OF THE INVENTION

One aspect of the invention resides is a device that includes a bottle opener to open bottles and bottle cap holder to hold bottle caps.

The bottle opener is made of a rigid material, such as metal, and includes a flat portion, an angled portion and a curved portion. The angled portion is between the flat portion and the curved portion and is arranged to extend in a manner that angles forwardly of the flat portion. The curved portion extends further forwardly of the angled portion. An elongated slot extends in a transverse direction bounded by the curved portion and the angled portion. The flat portion may have mounting holes into which may be secured mounting screws to mount to a wall. Also, the flat portion may have adhesive strips arranged on a face that faces away from the overhang of the angled portion.

The cap holder is made of a flexible material, such as rubber, and defines a bottom, upstanding sidewall and a mouth. The upstanding sidewall has a rear with an elongated slot through which may be inserted the bottle opener. The upstanding sidewall preferably is longer at its rear than in the front.

### BRIEF DESCRIPTION OF THE DRAWING

For a better understanding of the present invention, reference is made to the following description and accompanying drawings, while the scope of the invention is set forth in the appended claims.

FIG. 1 is an isometric view of a bottle opener, bottle cap holder and two mounting screws prior to assembly in accordance with the invention.

FIG. 2 is an isometric view of the bottle opener of FIG. 1 inserted into a slot in the bottle opener of FIG. 1 and mounted to a wall by the mounting screws in accordance with the invention.

FIG. 3 is an isometric view of FIG. 2 showing the manner in which a bottle to be opened is positioned just prior to removing the bottle cap.

FIG. 4 is an isometric view of FIG. 2 but after the bottle cap has been removed to fall into the holder and after moving the opened bottle away from the bottle opener.

FIG. 5 is an isometric view of the bottle opener of FIG. 2 attached to the wall and the bottle cap holder of FIG. 2 removed from the bottle opener and turned upside down to allow bottle caps to fall out through the mouth of the upside down bottle cap holder.

FIG. 6 is an isometric view of the bottle opener in accordance with the invention showing the mounting surface of the flat portion with adhesive strips.

FIG. 7 is an isometric view of the bottle opener of FIG. 6, but whose mounting surface is adhered to a wall.

FIG. 8 is an isometric view of the bottle opener of FIG. 7, but showing the two mounting screws passing into the two mounting holes of the flat portion of the bottle opener and threadably engaging the wall.

FIG. 9 is an isometric view of the bottle cap holder, whose slot is being fitted onto the curved portion of the bottle opener.

FIG. 10 is an isometric view of the bottle cap holder fitted further onto the curved portion of the bottle opener than in FIG. 9.

FIG. 11 is an isometric view of the bottle cap holder of FIGS. 9 and 10 fully fitted onto the curved portion of the bottle opener in accordance with the invention so as to remain in position held solely by the bottle opener secured to the wall.

FIG. 12-17 are isometric views the showing the manner of placing a capped bottles in position for prying off their caps in accordance with the invention.

FIGS. 18-19 are progressive isometric views that show the cap of FIGS. 12-17 being pried off.

FIGS. 20-21 are progressive isometric views that show the bottle cap holder being removed from the bottle opener to empty its contents.

FIGS. 22-24 are progressive isometric views that show replacement of the bottle cap holder onto the bottle opener.

### DESCRIPTION OF THE PREFERRED EMBODIMENT

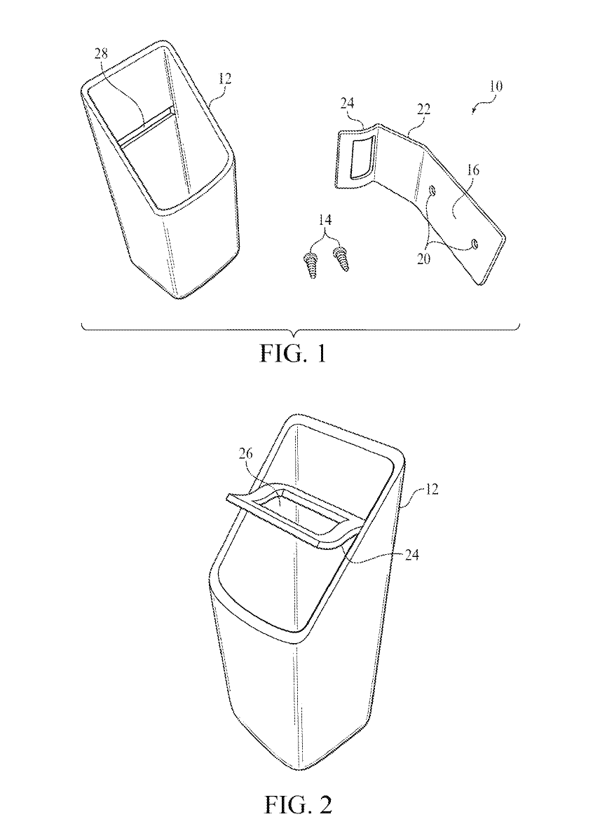

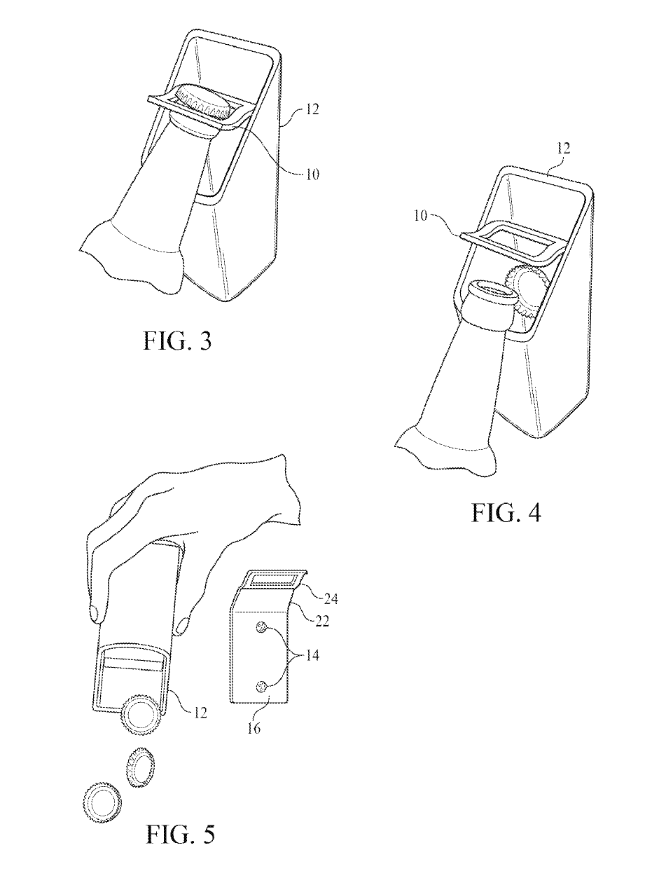

Turning to the drawing, FIG. 1 shows a bottle opener 10, a bottle cap holder 12, and two mounting screws 14 all in accordance with the invention. The bottle opener includes a flat portion 16 with a mounting surface 18 and two holes 20, an angled portion 22 and a curved portion 24 having an open window portion 26. An elongated holder mounting slot 28 extends in a transverse direction and bounded between the angled portion 22 and the curved portion 24.

The two mounting screws 14 may be made of stainless steel. With the mounting surface 18 of the flat portion 16 against a wall to which the bottle opener 10 is to be secured, the two mounting screws 14 are inserted into the two holes 20 with their threaded stems secured to the wall.

A 2-sided foam tape 30 can also be used when screws cannot. The 2-sided foam tape 30 also helps keep the opener in place while securing the stainless steel mounting screws 14. Stainless steel mounting screws are used since the opener will be used inside and outside and they should not rust.

Using the bottle opener 10, with its angled portion 22 extending away from the cooler wall as a mounting bracket for retaining the holder, the mounting slot 28 in the flat back or rear of the bottle cap holder 12 receives the angled portion 22. The flat back makes it easy to mount the bottle cap holder 12. It sat secure between the opener and the mounting surface. Thus, the mounting angle of the opener and it's flat surface area keeps the holder from moving around side to side or from sliding up and off by accident.

The design of the opener's pry edge in accordance with the invention was moved from bottom to top of the window. Two more angles were needed to keep the desired 27 degrees of the loading surface this is the surface the cap will rest flat against when prying. The pry edge on the top of the window pushes the caps to the back of the bottle after prying. This ensures the caps fall correctly into the bottle cap holder 12. The two new angles of the pry edge and its new location transfer force of the cap being pried off when the opener is use. The force is directed down from the pry edge to the mounting surface and to the mounting wall. The direction of the force is now towards the mounting surface, pushing the cap towards the mounting wall not away. Pulling away from the wall can cause the mounting screws or tape to fail.

The bottle opener 10 is more compact because the holder is made of rubber, which gives when the bottle is pushed against when prying a cap. It will give so the bottle angle can be made. The rubber holder will also keep its shape after being bumped. The holder shape also protects the opener from being hit by accident.

For the sake of convenience the combination of the mountable bottle opener and removable bottle cap holder in accordance with the invention will be referred collectively as a Bottle Cap Caddy device.

Of being convenient, the Bottle Cap Caddy device will not get lost, does not need to be held on one's person, can go anywhere on anything. Once installed, the Bottle Cap Caddy device cannot be misplaced, lost like most portable openers.

The Bottle Cap Caddy device is easy to use when low to the ground or at eye level. Caps drop automatically into holder and are less likely be littered since they are conveniently stored.

The bottle cap holder 12 can be easily removed, emptied, washed, and reinstalled. The opener can also be used without holder in place. The cap holder can easily be removed without fasteners clips or screws and emptied into a trash receptacle.

The bottle cap holder 12 also collects and holds any spilled beverages caused sometimes by opening a twist off or pry cap. The bottle cap holder 12 can be removed, emptied and washed in a dishwasher or sink. While the opener remains mounted and still can be used as a bottle opener.

The Bottle Cap Caddy can be easily mounted with two Stainless mounting screws 14 and or two sided foam tape 30. It can be mounted to a cooler, walls, refrigerators, bars, RVs, garbage pails, boats, decks any surface.

The stainless steel screws 14 and opener will not rust so it could be used or left outside. The holder is made of a rubber material that can be used or left outside. Beverages do not spill out when used properly. Nor does it spill on you when used, like other portable openers can.

The holder basic design and or color can be modified so it can be used as a promotional tool. The holder's cap catcher can be shaped as a Shoe, football, boat dingy, car or truck, fish, bottle and unlimited shapes. The front and sides of the holder can be used as advertisement space for promotional purposes. Sport and school logos and colors can be placed on holder.

The two main parts of the Bottle Cap Caddy the opener and holder can be easily produced with common materials and easy shapes.

This bottle opener 10 is mounted to just about anything, including portable coolers and having an opener handy. It has two sided foam tape that is water resistant, two holes on “mounting surfaces” for 2 #8×½″ stainless steel Philips pan head sheet metal screws 14. This will enable the user to mount to plastic, metal, wood, refrigerator, fiberglass, and common materials for coolers, decks, boats, AV, hot tubs, garbage cans, decks, or bars.

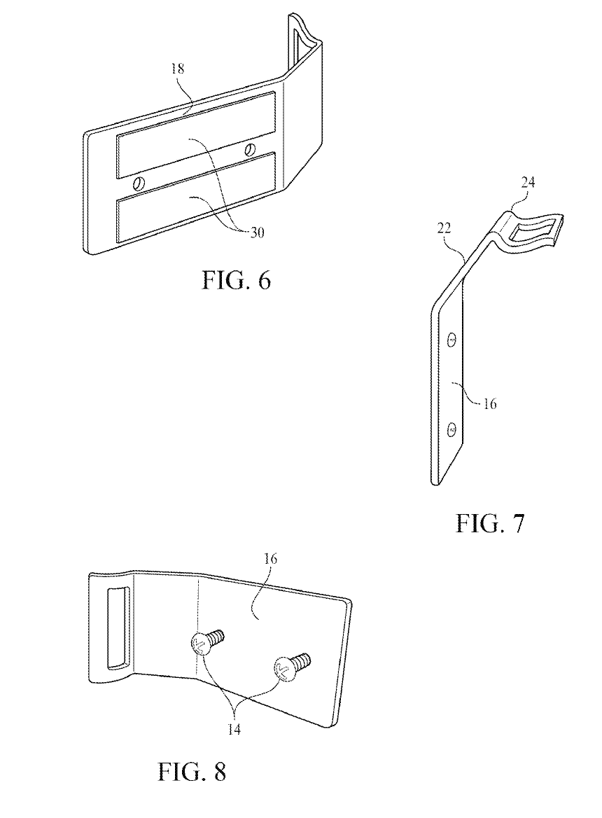

Mounting of the Bottle Cap Caddy may be as follows. As shown in FIG. 6, peel away backing from the 2 sided foam tape 28 from the back of the bottle opener. Turning to FIG. 7, stick the bottle opener 10 level, with opener window 26 on top and mounting holes 20 below in alignment with a desired location on a desired wall mounting surface. The adhesive foam tape 28 will hold the bottle opener 10 in place while installing the stainless steel mounting screws 14 through the mounting holes 20 into wall mounting surface as shown in FIG. 8. Screw in both screws until the bottle opener 10 is secure to mounting surface.

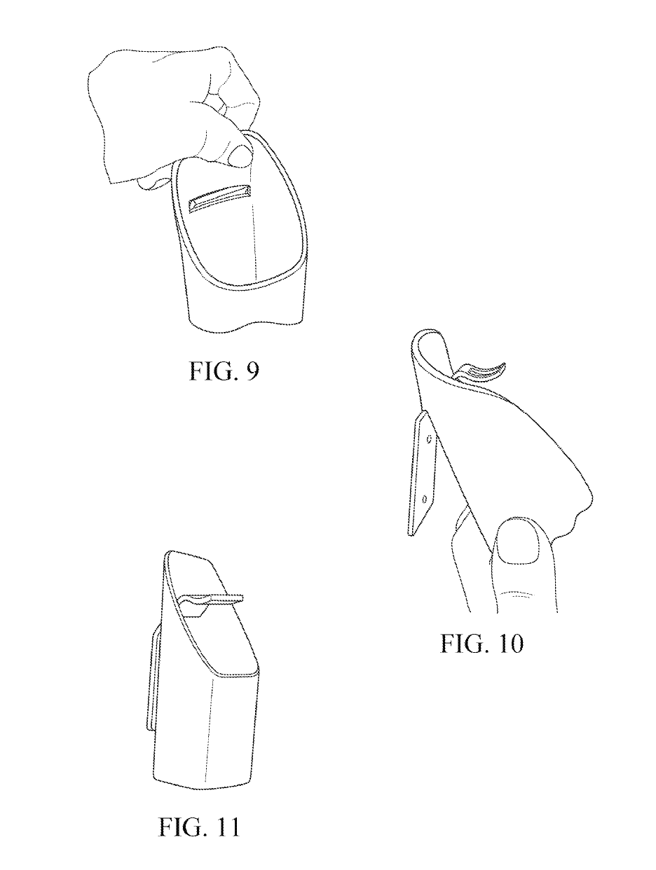

To install the bottle cap holder 12 onto the bottle opener 10, hold “top holder grip” and sides of “holder” and with “holder base” down and flat back facing opener as shown in FIG. 9. Direct the holder mounting slot over the bottle opener 10 as shown in FIG. 10 until it rests on the angle portion against the mounting surface as shown in FIG. 11. If desired, the bottle opener 10 can be used without the bottle cap holder 12.

The Bottle Cap Caddy may be used to open caps on capped bottles as follows.

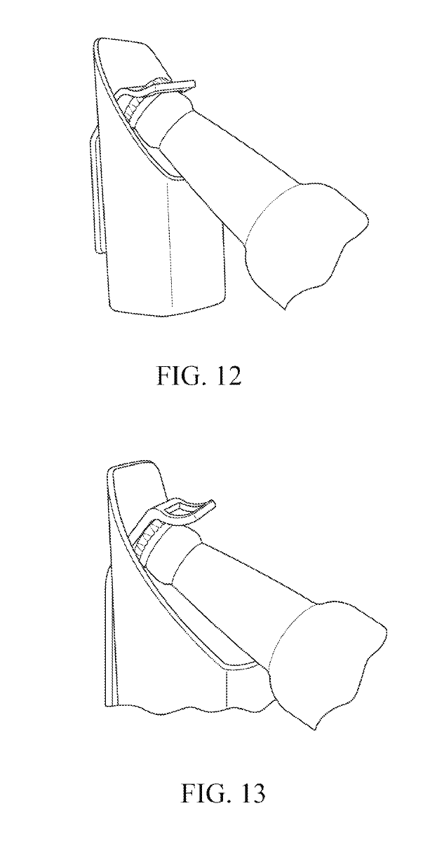

Turning to FIGS. 11 and 12, tilt the bottle with twist or sealed cap under the opener window 26, placing the bottle flat cap against the opener's “loading surface”.

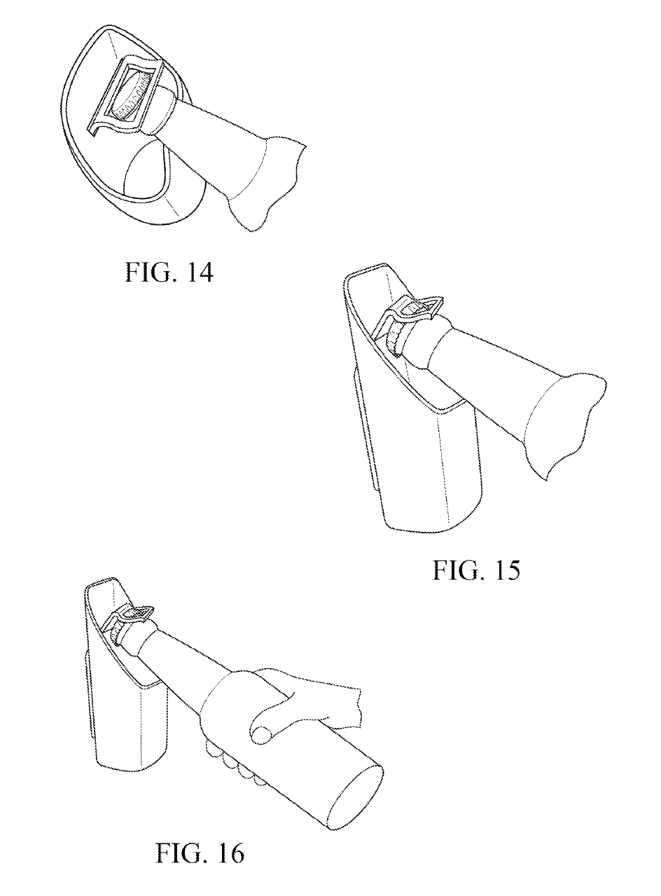

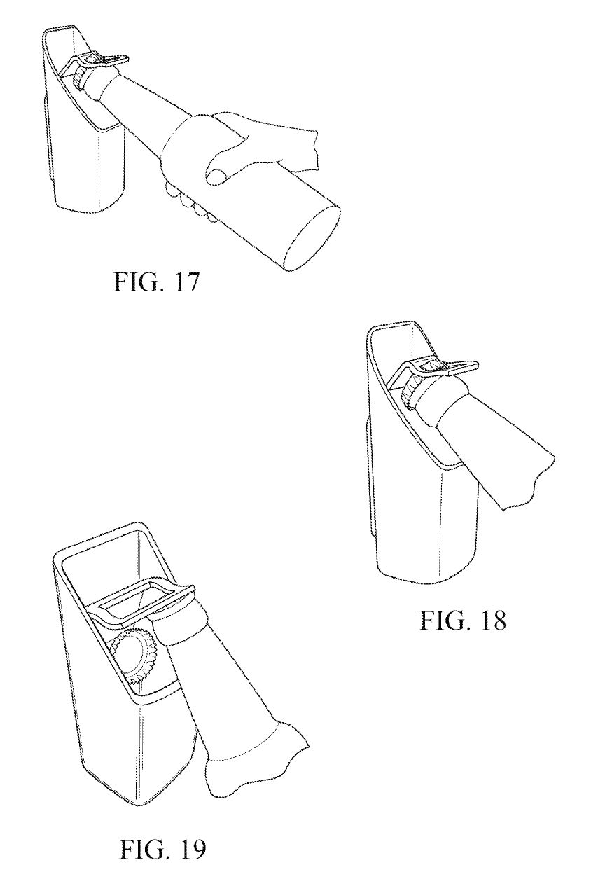

Turning to FIGS. 13 and 14, move the cap up to opener window 26 and pry edge, keeping flat the surface of the cap until the cap is in the opener window 26 and the edge of cap is resting on the pry edge.

Turning to FIGS. 15 and 16, push down on base of bottle, pushing it towards the bottle cap holder 12 and the mounting wall.

Turning to FIG. 18, the bottle cap will catch the “pry edge” and release from bottle. The cap will release with minimum spill of beverage.

Turning to FIG. 19, the cap will drop along the loading surface and into confines of the cap holder 12.

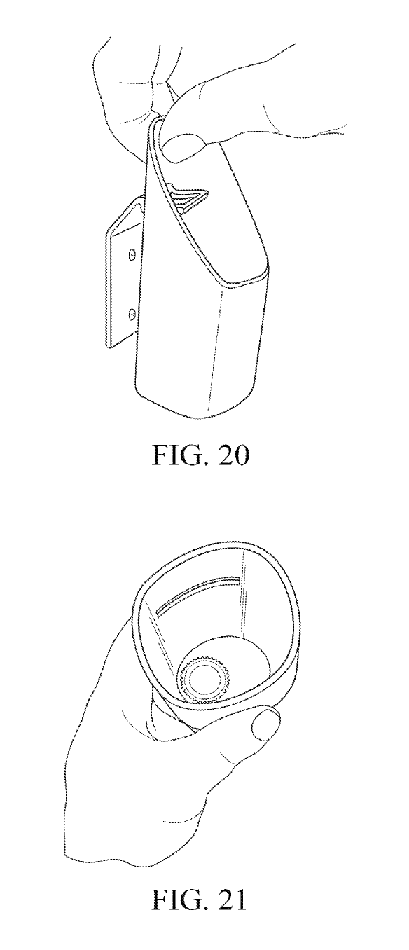

Turning to FIG. 20, when the bottle cap holder 12 is full, the bottle cap holder 12 can be removed by separating it from the bottle opener 10. Grab the bottle cap holder 12 by the top holder grip and pull up and away from the wall mounting surface following the opener's angles until the bottle cap holder 12 is free from the bottle opener 10.

Turning to FIG. 21, tip the cap holder 12 so its mouth inclines toward trash receptacle. The bottle cap holder can be washed with soapy warm water and/or dish washer when needed. Also, the bottle cap opener can be used without the bottle cap holder 12 in place.

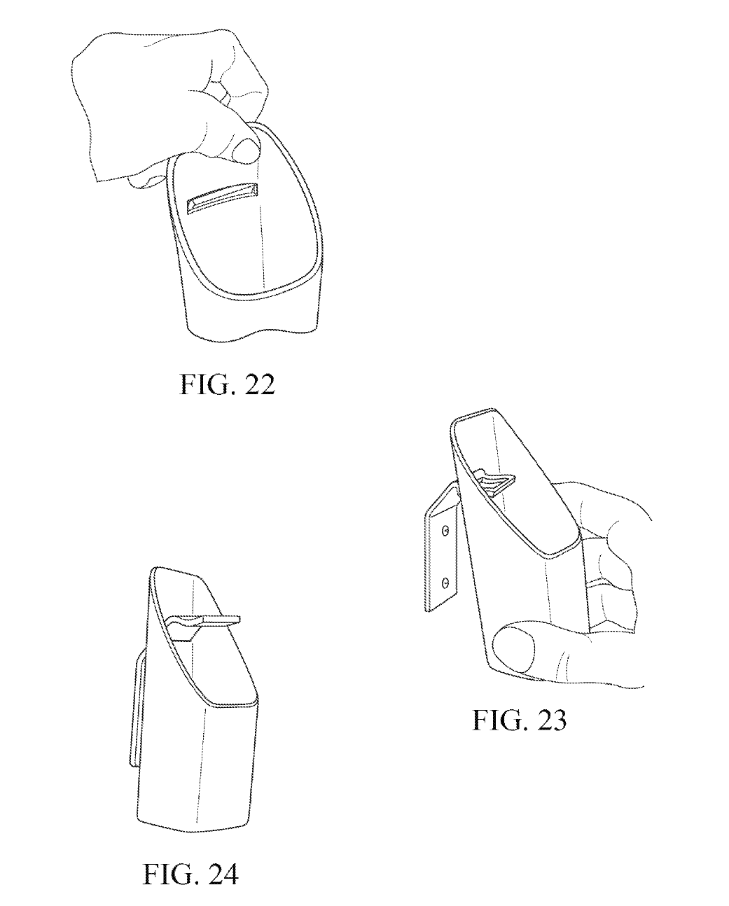

Turning to FIGS. 22-24, to replace the bottle cap holder 12 onto the bottle opener 10, hold the top holder grip shown in FIG. 22 and the sides of bottle cap holder 12 and with the holder base oriented down and flat back facing the bottle opener. Direct the holder mounting slot 28 to feed onto the curved portion and then the angled portion of the bottle opener 10 until it rests on a mounting angle and against the forward face (reverse side of the mounting surface 18) of the bottle opener 10.

While the foregoing description and drawings represent the preferred embodiments of the present invention, it will be understood that various changes and modifications may be made without departing from the scope of the present invention.

What is claimed is:

1. A bottle cap device, comprising a body having a substantially flat portion, an angled portion and a curved portion, the curved portion having an open region bounded by edges suited to pry off a bottle cap under manual force, the angled portion extending between the flat portion and the curved portion, and means for mounting the flat portion to a flat surface.

2. The bottle cap device of claim 1, wherein the flat portion includes mounting holes, the means for mounting including mounting fasteners that fit into the mounting holes.

3. The bottle cap device of claim 1, wherein the means for mounting includes adhesive strips on a face of the flat portion that adhere to the flat surface.

4. The bottle cap device of claim 2, wherein the means for mounting also includes adhesive strips on a face of the flat portion.

5. The bottle cap device of claim 1, wherein the angled portion extends at an angle relative to the flat portion of about 27 degrees.

6. The bottle cap device of claim 1, further comprising a bottle cap holder, the bottle cap holder having a base and a sidewall upstanding from the base, the sidewall including a rear having a slot sized to accommodate being inserted onto the curved portion and then the angled portion.

7. The bottle cap device of claim 6, wherein the bottle cap holder is made of a flexible material and has a mouth, the mouth being angled due to the rear being longer than a front of the bottle cap holder with the bottle cap holder retained onto the angled portion of the bottle opener via the slot.

8. A method of installing a bottle cap device, comprising the steps of mounting a substantially flat portion of a body to a flat surface, the body also having an angled portion and a curved portion, the curved portion having an open region bounded by edges suited to pry off a bottle cap under manual force, the angled portion extending between the flat portion and the curved portion.

9. The method of claim 8, wherein the mounting includes fitting fasteners in mounting holes in the flat portion.

10. The method of claim 8, wherein the mounting includes adhering to the flat surface with adhesive strips on a face of the flat portion.

11. The method of claim 9, wherein the mounting includes adhering to the flat surface with adhesive strips on a face of the flat portion.

12. The method of claim 8, further comprising extending the angled portion relative to the flat portion at an angle of about 27 degrees.

13. The method of claim 8, further comprising accommodating a bottle cap holder onto the bottle opener, the bottle cap holder having a base and a sidewall upstanding from the base, the sidewall including a rear having a slot sized to accommodate being inserted onto the curved portion and then the angled portion.

14. The method of claim 13, wherein the bottle cap holder is made of a flexible material and has a mouth, the mouth being angled due to the rear being longer than a front of the bottle cap holder with the bottle cap holder retained onto the angled portion of the bottle opener via the slot.
